(19) United States
(12) Patent Application Publication
(10) Pub. No.: US 2025/0284626 A1
(43) Pub. Date: Sep. 11, 2025

(54) VERSION-BASED UPDATING IN A NON-VOLATILE MEMORY EXPRESS ENVIRONMENT

(71) Applicant: DELL PRODUCTS L.P., Round Rock, TX (US)

(72) Inventor: Sakti Lakshmiy R PAULCHAMY, Chennai (IN)

(73) Assignee: DELL PRODUCTS L.P., Round Rock, TX (US)

(21) Appl. No.: 18/601,943

(22) Filed: Mar. 11, 2024

(51) Int. Cl. G06F 12/02

(52) U.S. Cl. CPC G06F 12/0223

(57) ABSTRACT

Embodiments herein provide a version mechanism that may be used to limit the information that is shared to entities in a non-volatile memory express (NVMe) environment. A generation counter, timestamp-based versioning, or other versioning mechanism may be used. In one or more embodiments, a log page request from a requesting entity contains versioning information as part of the request that identifies the version of the information that has last been seen by the requesting entity. A centralized discovery controller may use this versioning information to provide a response (e.g., a list of log page entries that have changed since the last seen information for the requesting entity). Thus, instead of a full list of entities that are relevant to/accessible by the requesting entity being sent, only those entities that have experienced some change since the last exchange of information are communicated.

### BACKGROUND

### A. Technical Field

The present disclosure relates generally to information handling systems. More particularly, the present disclosure relates to handling information exchange due to a change or changes in a nonvolatile memory express environment.

### B. Background

The subject matter discussed in the background section shall not be assumed to be prior art merely as a result of its mention in this background section. Similarly, a problem mentioned in the background section or associated with the subject matter of the background section should not be assumed to have been previously recognized in the prior art. The subject matter in the background section merely represents different approaches, which in and of themselves may also be inventions.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A quite common and useful collection of information handling systems is a storage area network (SAN). An implementation of a SAN is a non-volatile memory express over fabrics (NVMe-oF). The handling of information exchanges in an NVMe-OF environment is typically quite regimented. In an NVMe-oF ecosystem, requests for information may be made via a get log page command. Currently, such requests are generic—they are irrespective of any changes that occurred. That is, the response to such a request is typically a full list of entities (e.g., hosts or storage subsystems) that are accessible by the requesting entity. There is no way currently to query or limit the received information to information related to a recent change or changes.

Accordingly, it is highly desirable to find new, more efficient ways to exchange information in a storage area network environment, particularly one that uses an implementation of NVMe-oF.

### BRIEF DESCRIPTION OF THE DRAWINGS

References will be made to embodiments of the disclosure, examples of which may be illustrated in the accompanying figures. These figures are intended to be illustrative, not limiting. Although the accompanying disclosure is generally described in the context of these embodiments, it should be understood that it is not intended to limit the scope of the disclosure to these particular embodiments. Items in the figures may not be to scale.

FIG. 1 (“FIG. 1”) depicts an example NVMe-OF environment for counter-based versioning, according to embodiments of the present disclosure.

FIG. 2A and FIG. 2B depict a counter-based versioning methodology, according to embodiments of the present disclosure.

FIG. 3 depicts an updated NVMe-OF environment of FIG. 1, according to embodiments of the present disclosure

FIG. 4 depicts an updated NVMe-OF environment of FIG. 3, according to embodiments of the present disclosure

FIG. 5 depicts an example NVMe-oF environment for timestamp-based versioning, according to embodiments of the present disclosure.

FIG. 6A and FIG. 6B depict a timestamp-based versioning methodology, according to embodiments of the present disclosure.

FIG. 7 depicts an updated NVMe-OF environment of FIG. 5, according to embodiments of the present disclosure

FIG. 8 depicts an updated NVMe-OF environment of FIG. 7, according to embodiments of the present disclosure

FIG. 9 depicts a simplified block diagram of an information handling system, according to embodiments of the present disclosure.

FIG. 10 depicts an alternative block diagram of an information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure.

A service, function, or resource is not limited to a single service, function, or resource; usage of these terms may refer to a grouping of related services, functions, or resources, which may be distributed or aggregated. The use of memory, database, information base, data store, tables, hardware, cache, and the like may be used herein to refer to system component or components into which information may be entered or otherwise recorded. The terms “data,” “information,” along with similar terms, may be replaced by other terminologies referring to a group of one or more bits, and may be used interchangeably. The terms “packet” or “frame” shall be understood to mean a group of one or more bits. The term “frame” shall not be interpreted as limiting embodiments of the present invention to Layer 2 networks; and, the term “packet” shall not be interpreted as limiting embodiments of the present invention to Layer 3 networks. The terms “packet,” “frame,” “data,” or “data traffic” may be replaced by other terminologies referring to a group of bits, such as “datagram” or “cell.” The words “optimal,” “optimize,” “optimization,” and the like refer to an improvement of an outcome or a process and do not require that the specified outcome or process has achieved an “optimal” or peak state.

It shall be noted that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall also be noted that although embodiments described herein may be within the context of implementations of NVMe environments, aspects of the present disclosure are not so limited. Accordingly, the aspects of the present disclosure may be applied or adapted for use in other contexts.

### A. General Overview

For NVMe-oF environments that include a centralized discovery controller (CDC), an NVMe entity, such as a host or storage subsystem, may make discovery requests to the CDC to obtain information that is maintained by the CDC. Typically, a discovery process is made via a get log page command. For example, an NVMe host may send a get log page request to the CDC. The CDC responds with discovery log page(s) that include specific information. A log page response may include such information as: (1) network address (i.e., details about how to reach an NVMe subsystem to which the requesting host is authorized to access), and (2) a unique subsystem NON (NVMe Qualified Name), which is an identifier that uniquely identifies the subsystem. In one or more embodiments, other information may be included in that or one or more additional responses. Given this information, the requesting host may connect with the identified subsystem. Typically, this connection is effected by the host issuing an NVMe connect command to establish a connection to a storage resource within the NVMe subsystem identified in the CDC's response.

As noted above, in an NVMe-oF ecosystem, the handling of information tends to follow set forms and formats. Currently, a discovery get log page request is generic, and the response from the CDC will typically include a full list of entities that are accessible to the requesting entity. There is no way currently to query or limit the received information to information related to a recent change or changes.

Accordingly, embodiments herein provide a version mechanism that may be used in conjunction with responding to requests for information to limit the information that is returned to a requesting entity. In one or more embodiments, a counter, timestamp-based versioning, or other versioning identifier may be used as a versioning mechanism. In one or more embodiments, the get log page request from a requesting entity contains versioning information (e.g., a counter or timestamp) as part of the request that identifies a current state for the requesting entity (i.e., the version of the information that has last been seen by the requesting entity). The CDC may then use this versioning information to generate and provide a response (e.g., a list of get log page entries that have changed since the last seen information for the requesting entity). Thus, instead of a full list of entities that are relevant to/accessible by the requesting entity being sent to the requesting entity, only those entities that have experienced some change since the last exchange of information will be communicated.

In one or more embodiments, a general flow of operations for a discovery process that utilizes a versioning mechanism (e.g., a counter or timestamp) based get log page request for an entity (e.g., a host or subsystem) may be as follows: 1. An entity (e.g., a host or subsystem) may initiate a transmission control protocol (TCP) connection to a centralized discovery controller (CDC).

2. After a fabric connect command and controller has been enabled, a get log page command returns an initial get log page response.

3. At the CDC, the get log pages' entry keys may be maintained for user-configured time and for a generation counter. The values may be reset either by user configuration or after a get log page response is sent out. Typically, an NVMe end device/entity registers its information as a discovery log page entry, which includes values such as Transport Type, Family, Transport Address, Address Family, SubType, Transport Requirement, Port ID, Controller ID, and other such information that uniquely identifies the end device. A CDC may use this stored information about the end devices and exchange at least some of this information with other end devices based on zoning configuration, which may be maintained in a namespace or a zone database server.

4. A host or subsystem may either query a full list (e.g., using a discovery/host discovery get log page) or may use versioning information (e.g., a timestamp or a generation counter) as part of a get log page request to obtain a subset of get log page information.

5. Responsive to receiving a discovery/host discovery get log page request with timestamp version information, the list maintained internally may be cleared on sending a successful response.

The above example overview is provided by way of helping to provide initial context. Additional details and different embodiments are provided in the next section.

Finally, it is noted that one skilled in the art will recognize that the embodiments herein provide several benefits. First, they reduce bandwidth usage because only the change list is sent in reply rather than the full list. Second, the smaller list facilitates ease of get log page command processing at end devices-especially whenever there are minimal changes of information in discovery log page data. Third, an embodiment may comprise an entity periodically checking with the CDC for changes; that is, the expiration of a time period may be a condition to trigger checking with the CDC for changes. In such embodiments, the difference in data that occurred since the last check-in time period may be returned. One skilled in the art shall recognize other benefits not expressly enumerated above.

### B. System and Method Embodiments

### 1. Counter-based Versioning Embodiments

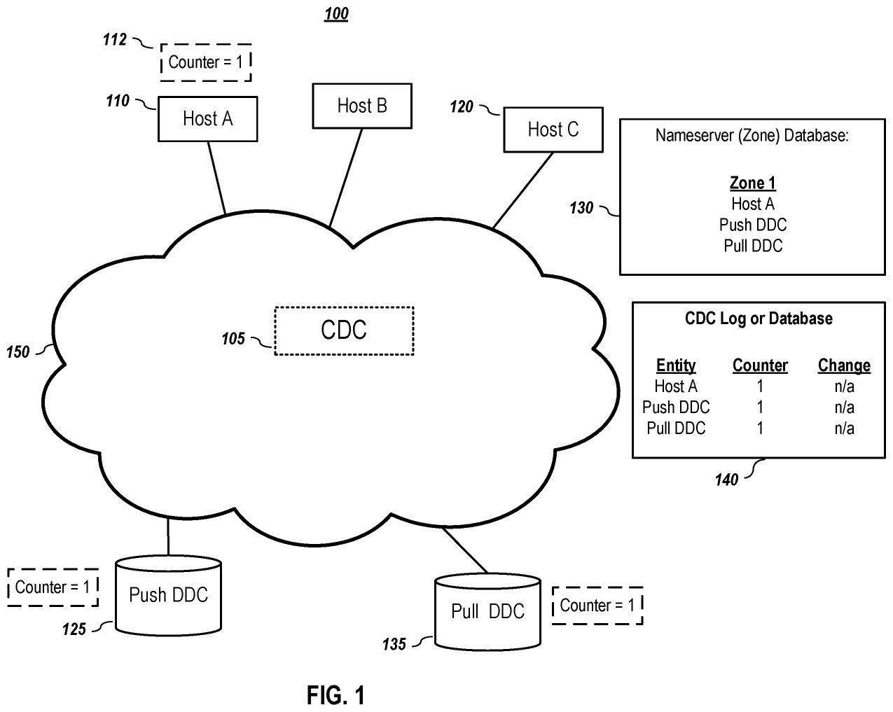

FIG. 1 depicts an example NVMe-oF environment, according to embodiments of the present disclosure. Depicted is an NVMe-OF environment 150 that includes a centralized discovery controller (CDC) 105. The CDC may be operating on a single information handling system or may be distributed to a set of information handling systems that exist within the NVMe network 150. In the depicted example there are a plurality of hosts, host A 110, host B, and host C 120, and there are two storage subsystems, a push direct discovery controller (DDC) of a storage subsystem 125 (hereinafter, “push DDC) and a pull DDC of a storage subsystem 135 (hereinafter, “pull DDC”). The “push” and “pull” qualifiers related to the discovery process used for the storage subsystems. In one or more embodiments, a push DDC may retrieve a host discovery log page by issuing a get log page command, and a pull DDC may retrieve a host discovery log page by issuing a pull DDC request notification (e.g., a pull_DDC_request asynchronous event notification (AEN)). It shall be noted that any type of storage subsystem (push, pull, neither, other, etc.) may be utilized in embodiments herein.

In the depicted example, a zone (namely, Zone 1) has been defined in a nameserver (or zone) database 130. For NVMe-oF environments, zones may be maintained by the CDC, which may also be referred to as a root discovery controller. In one or more embodiments, a zone (which may also be referred to as a zone group) is a unit of activation (i.e., a set of access control rules enforceable by the CDC). The members of the zone are host A 110, push DDC 125, and pull DDC 135. Once in a zone, the interfaces/entities (which may be referred to as zone members) are able to communicate with one another when the zone has been added to an active zone set of the nameserver database 130. Zones may be created for a number of reasons, including to increase network security, and to prevent data loss or data corruption by controlling access between devices or user groups.

Also depicted in FIG. 1 is a CDC log (or database or datastore) 140 that is used for tracking versioning. In the depicted embodiment, a counter mechanism is used, in which the log or database comprises, for a zone, the zone members (i.e., the entities), each zone member's counter value, and an indicator or descriptor of what changed. It shall be noted that the log/database may be configured differently and may comprise different information.

Also note that, in one or more embodiments, as part of the discovery or an initialization process, one or more of the entities may be assigned an initial counter value. For example, in the depicted embodiment of FIG. 1, each of the zone members are assigned an initial counter value of 1 (e.g., counter 112 for host A 110).

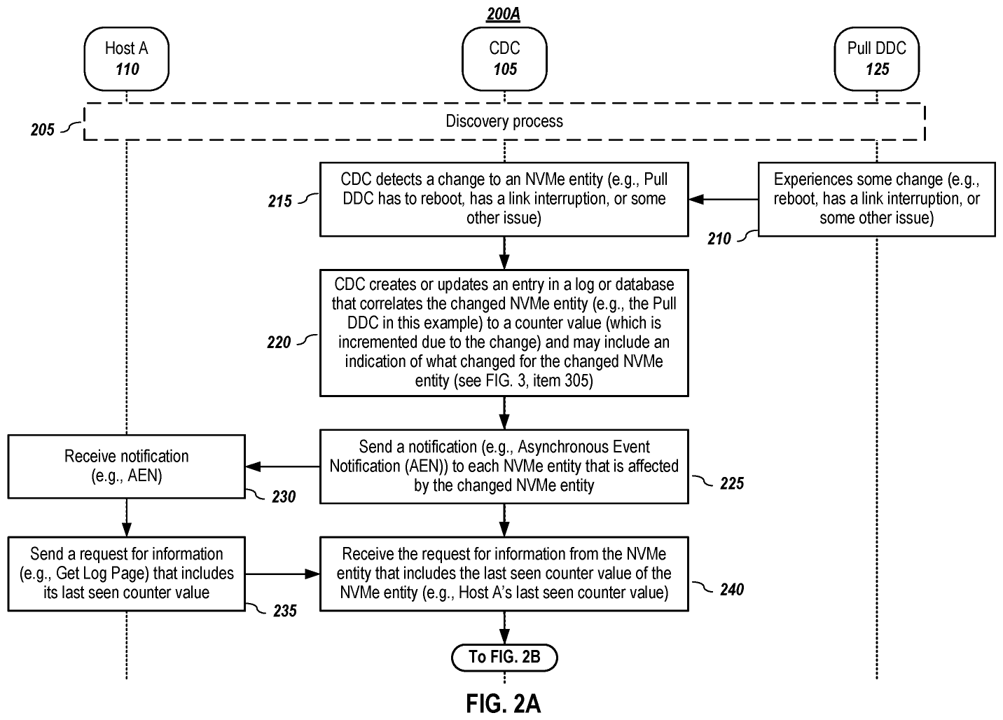

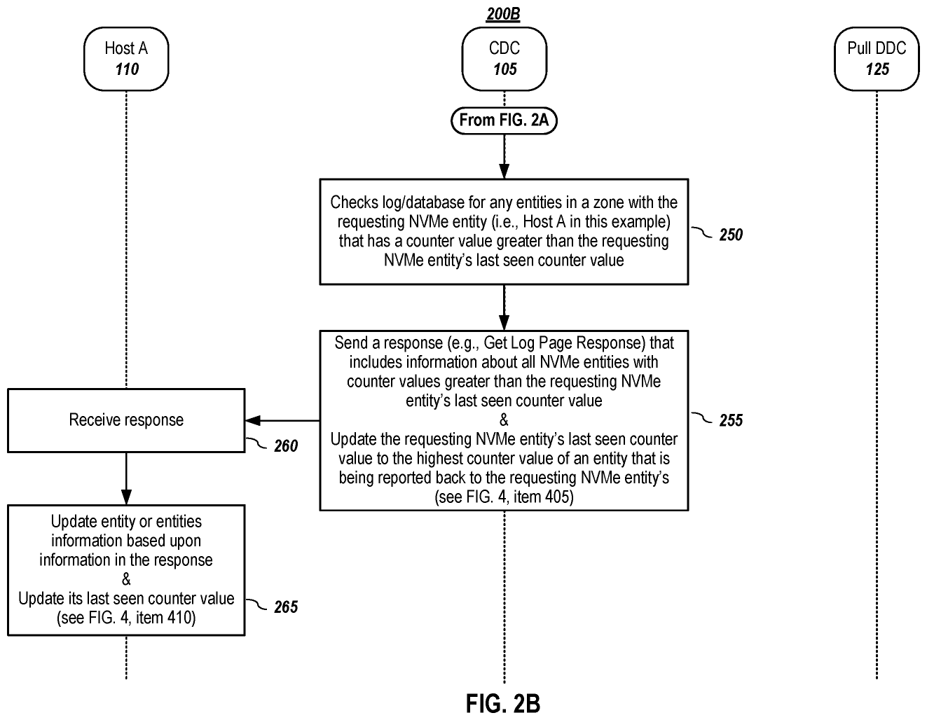

FIGS. 2A and 2B depict an example methodology for utilizing counter versioning, according to embodiments of the present disclosure. In one or more embodiments, the discovery process has occurred (205), which may be performed using typical NVMe discovery methods, push methods, pull methods, or any combination thereof. For sake of illustration, assume that pull DDC 125 experiences (210) some change. A change may be defined and may include any change to any property or state associated with the pull DDC 125, such as a reboot, connection (or link) interruption, or any other issue or change. In one or more embodiments, the CDC 105 detects (215) or is informed (e.g., by an admin, by the pull DDC, or by some other entity or information handling system in the fabric) of a change.

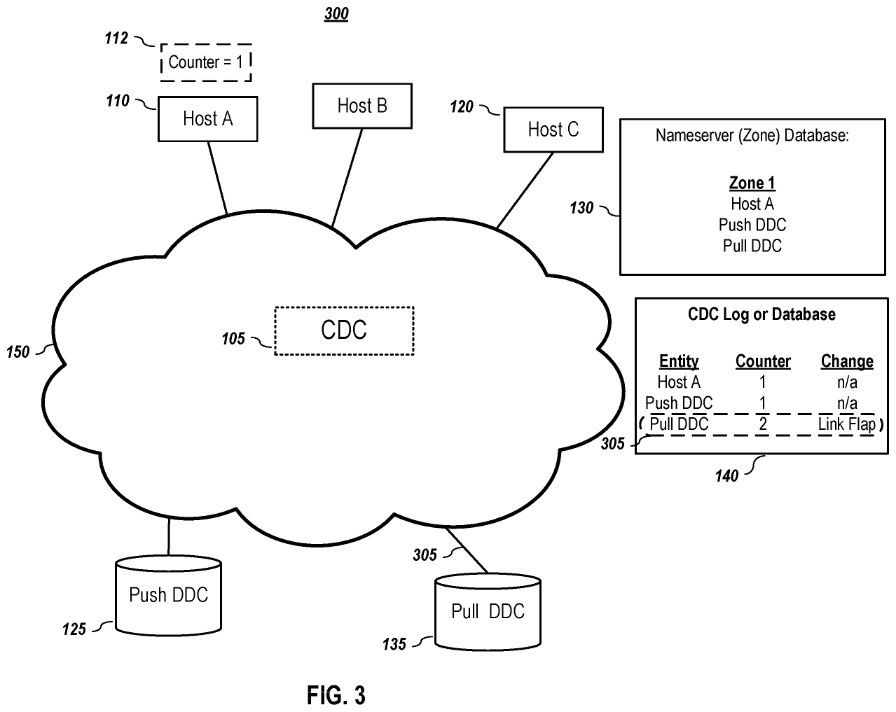

In one or more embodiments, the CDC 105 creates or updates (220) an entry in a log or database that correlates the changed NVMe entity (e.g., the pull DDC 125 in this example) to a counter value (which is incremented due to the change) and may include an indication of what changed for the changed NVMe entity. FIG. 3 depicts the system 100 in FIG. 1 in which the entry for the pull DDC in the CDC log 140 is updated 305 so that the counter incremented to “2” and a note was added to include what triggered the counter increment. The CDC sends (225) a notification (e.g., an Asynchronous Event Notification (AEN)) to each NVMe entity that is affected by the changed NVMe entity. As depicted in FIG. 2A, host A 110 receives (230) the notification, and sends (235) a request for information (e.g., Get Log Page request) that includes its last seen counter value, which is “1” in this case. The CDC receives (240) the request for information from the NVMe entity (i.e., host A in this example), which includes its last seen counter value (e.g., host A's last seen counter value).

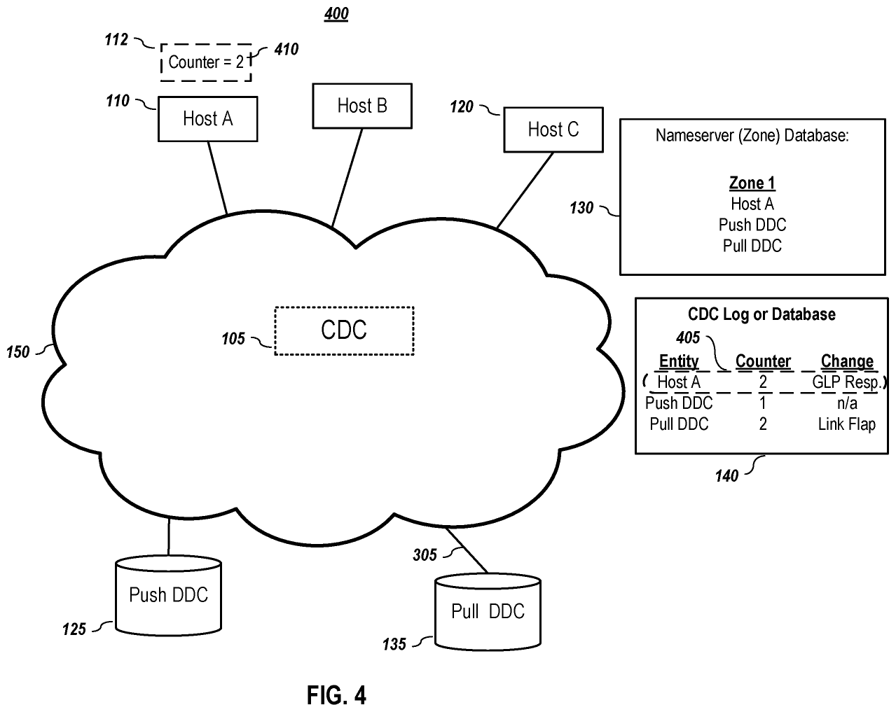

Continuing to FIG. 2B, the CDC checks its versioning log/database for any entities in a zone with the requesting NVMe entity (i.e., host A in this example) that has a counter value greater than the requesting NVMe entity's last seen counter value. As illustrated in FIG. 3, the only entity with a version greater than host A's counter value of 1 is the pull DDC. Therefore, the CDC composes and sends (255) a response (e.g., Get Log Page Response) that includes information about all NVMe entities with counter values greater than the requesting NVMe entity's last seen counter value. In one or more embodiments, the CDC also updates (255) the requesting NVMe entity's (i.e., host A 110) last seen counter value to the highest counter value of an entity that is being reported back to the requesting NVMe entity. FIG. 4 depicts an update to the log/database following successful sending of the response, according to embodiments of the present disclosure. Note item 405 in FIG. 4 show that version in host A has been updated to “2,” and the database may also include a note or reason about the last update—in this case, host A's version was updated due to it being send a response from the CDC.

Host A 110 receives (260) the response from the CDC that includes information about any entity in a zone with host A that has a change with a counter value of 2 or more. Host A may then update (265) information about the entity or entities based upon information in the response. In one or more embodiments, host A 110 may also update its last seen counter value to a counter value indicated in the response from the CDC. FIG. 4 shows that the counter value 410 for host A has been updated to “2.”

Note that, in one or more embodiments, the version number may be higher under different circumstances. For example, assume that at or around the time that the pull DDC 125 experienced its event that registered as a change, the push DDC 135 may have undergone two change events that were detected and logged by the CDC. The counter value for the push DDC 135 would be “3.” Also assume that before any notifications related to the push DDC changes were sent to host A, the CDC received the request (step 240) from host A that was in response to the notification (step 230) sent regarding the pull DDC. In reply, the CDC may send information related to any entity (at least any storage subsystem) in a zone with host A that has a version number greater than 1. Thus, information about both the pull DDC and the push DDC may be sent in response. Note also that the counter value for host A would be set to 3, since it has now seen all changes for counter values of 2 and 3. In one or more embodiments, the information exchange may be limited per zone.

Note that, for one or more embodiments, an existing generation counter may be repurposed for versioning. Currently, a generation counter exists for the purpose of ensuring that if a host obtains discovery log page information using multiple get log page requests, the host can ensure that a change in the contents of the data has not occurred. This is accomplished by the host reading the discovery log page contents in order (i.e., with increasing log page offset values) and then checks a generation counter after the entire log page is transferred. If the generation counter does not match the original value read, the host discards the log page read as the entries may be inconsistent. In one or more embodiments, the generation counter may be utilized for versioning as described above—although it should be noted that a different indicator, field, or value may be used for the counter.

### 2. Timestamp-Based Versioning Embodiments

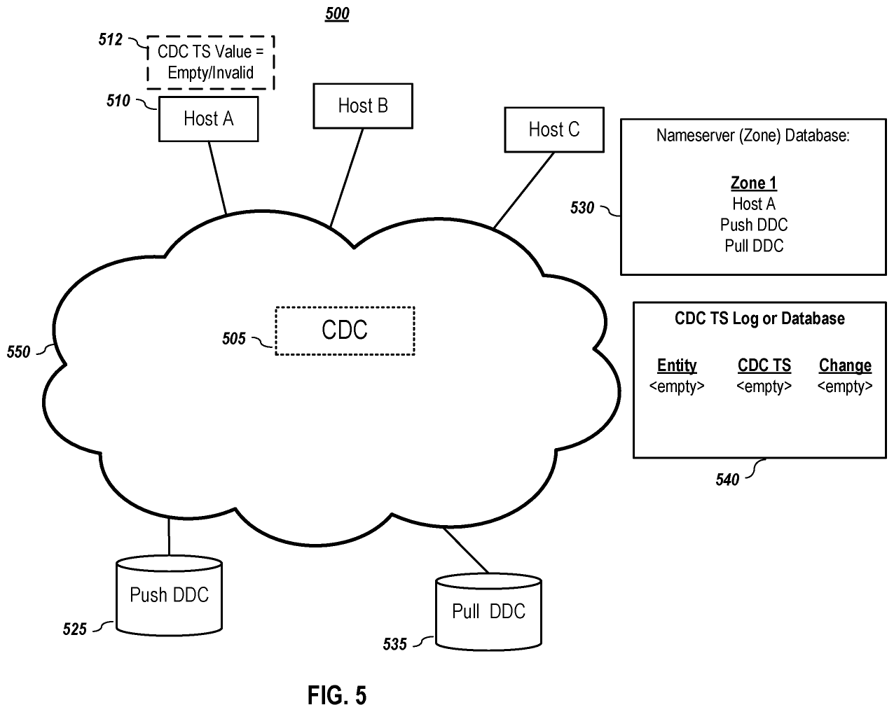

FIG. 5 depicts an example NVMe-oF environment for timestamp-based versioning, according to embodiments of the present disclosure. Depicted is an NVMe-OF environment 550 that includes a centralized discovery controller (CDC) 505. The CDC may be operating on a single information handling system or may be distributed to a set of information handling systems that exist within the NVMe network 550. In the depicted example there are a plurality of hosts, host A 510, host B, and host C, and there are two storage subsystems, a push direct discovery controller (DDC) of a storage subsystem 525 (hereinafter, “push DDC) and a pull DDC of a storage subsystem 535 (hereinafter, “pull DDC”).

In the depicted example, a zone (namely, Zone 1) has been defined in a nameserver (or zone) database 530. The members of the zone are host A 510, push DDC 525, and pull DDC 535. Once in a zone, the interfaces/entities (which may be referred to as zone members) are authorized to communicate with one another.

Also depicted in FIG. 5 is a CDC log or database 540 that is used for tracking versioning. In the depicted embodiment, a timestamp mechanism is being used, in which the log or database may comprise, for a zone member (i.e., an entity) of a zone, an associated timestamp value. The log/database 540 may also include an indicator or descriptor of what changed. It shall be noted that the log/database may be configured differently and may comprise different information.

Also note that, in one or more embodiments, as part of the discovery or an initialization process, one or more of the entities may or may not be assigned an initial timestamp value. For example, in the depicted embodiment of FIG. 5, no initial timestamp values are assigned.

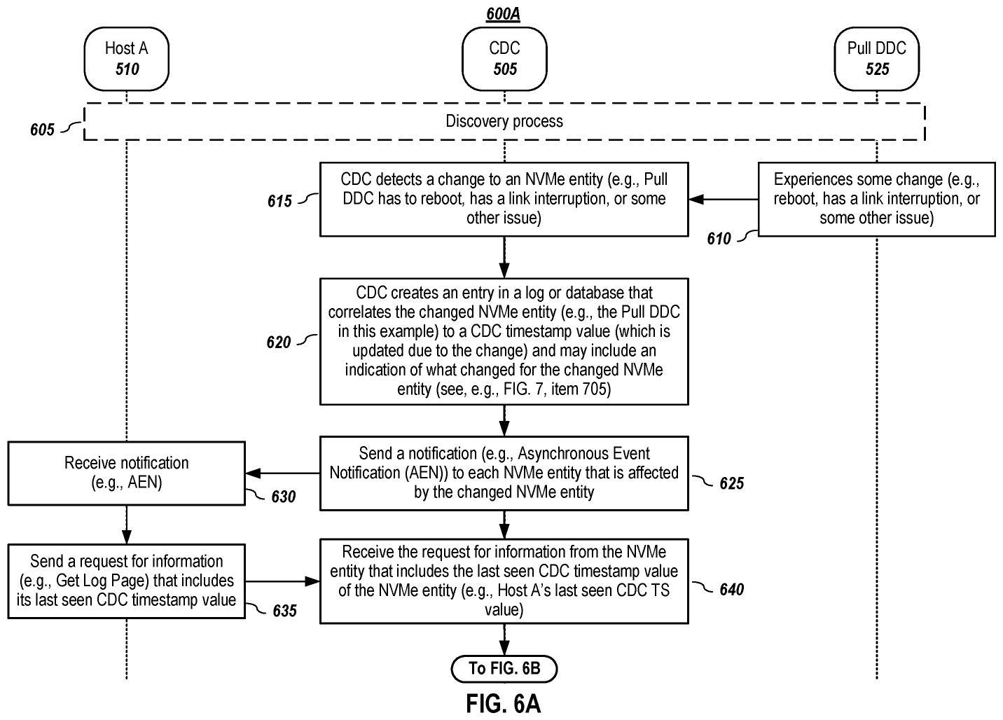

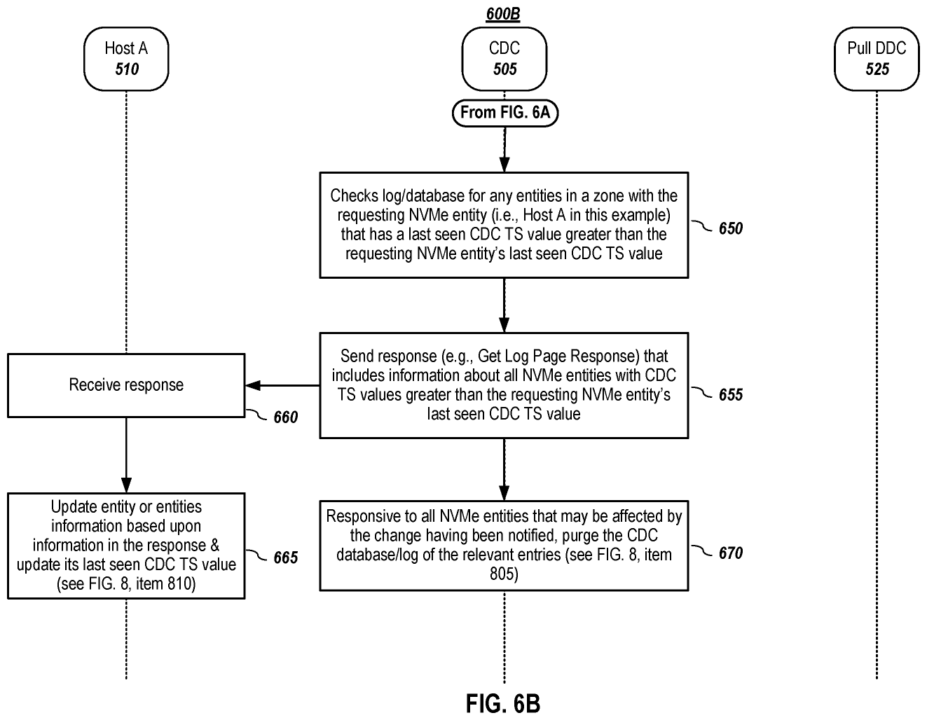

FIGS. 6A and 6B depict an example methodology for utilizing timestamp versioning, according to embodiments of the present disclosure. In one or more embodiments, the discovery process has occurred (605), which may be performed using typical NVMe discovery methods, push methods, pull methods, or any combination thereof. For sake of illustration, assume that pull DDC 525 experiences (610) some change. A change may be defined to include any change to any property or state associated with the pull DDC 525, as discussed previously. In one or more embodiments, the CDC 505 detects (615) or is informed (e.g., by an admin, by the pull DDC, or by some other entity or information handling system in the fabric) of a change.

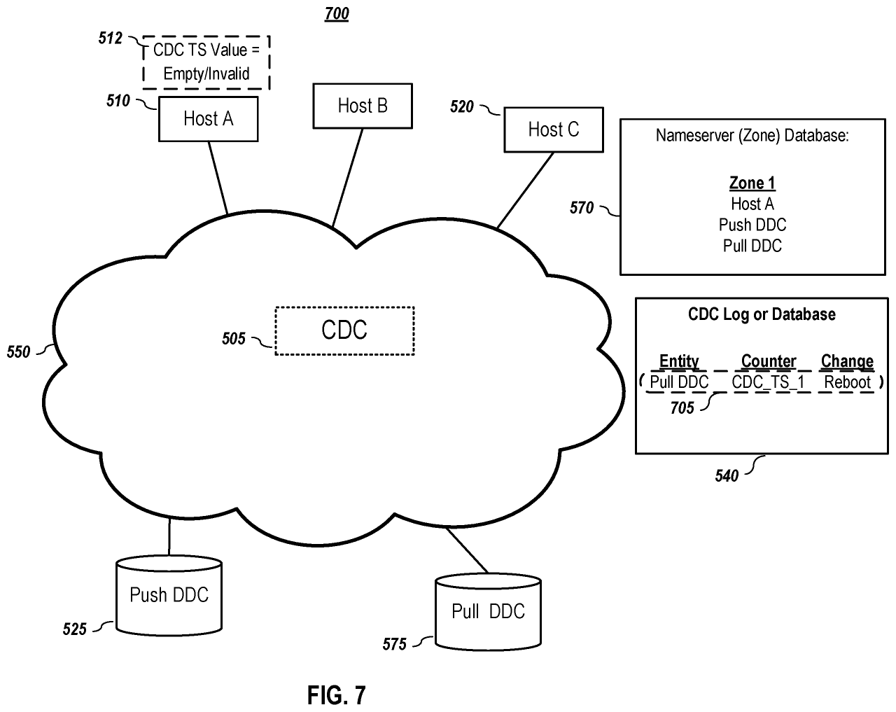

In one or more embodiments, the CDC 505 creates or updates (620) an entry in a log or database that correlates the changed NVMe entity (e.g., the pull DDC 525 in this example) to a CDC timestamp value (which is added or updated due to the change) and may include an indication of what changed for the changed NVMe entity. FIG. 7 depicts the system 500 in FIG. 5 in which the entry for the pull DDC in the CDC log 540 is updated 705 so that the entry includes the timestamp (e.g., CDC TS 1). In one or more embodiments, a note may be added to include what triggered the entry in the log/database 540. The CDC sends (625) a notification (e.g., an Asynchronous Event Notification (AEN)) to each NVMe entity that is affected by the changed NVMe entity (i.e., the pull DDC). As depicted in FIG. 6A, host A 510 receives (630) the notification, and sends (635) a request for information (e.g., Get Log Page request) that includes its last seen CDC timestamp (TS) value, which is “Empty” or “Invalid” in this example. The CDC receives (640) the request for information from the NVMe entity (i.e., host A in this example), which includes its last seen CDC timestamp value (i.e., host A's last seen CDC TS value, which is “Empty” or “Invalid” in this example).

Continuing to FIG. 6B, the CDC checks its versioning log/database 540 for any entities in a zone with the requesting NVMe entity (i.e., host A in this example) that has a CDC timestamp value greater than the requesting NVMe entity's last seen CDC timestamp value. As illustrated in FIG. 7, there is only one entry 705 with a version greater than host A's CDC timestamp value is the pull DDC. Therefore, the CDC composes and sends (655) a response (e.g., Get Log Page Response) that includes information about the NVMe entity or entities with CDC timestamp values greater than the requesting NVMe entity's last seen CDC timestamp value.

In one or more embodiments, responsive to all NVMe entities that may be affected by the change having been successfully notified, the CDC purges (670) its database/log 540 of the relevant entry or entries.

Typically, host information is provided to its zoned storage subsystems and vice versa, but hosts are typically not provided information about other hosts and similarly for storage subsystems (e.g., the pull DDC may not receive information about the push DDC). However, in one or more alternative embodiments (regardless of the versioning implementation), in addition to host A 510 being notified, the push DDC 525 may be similarly provided the information.

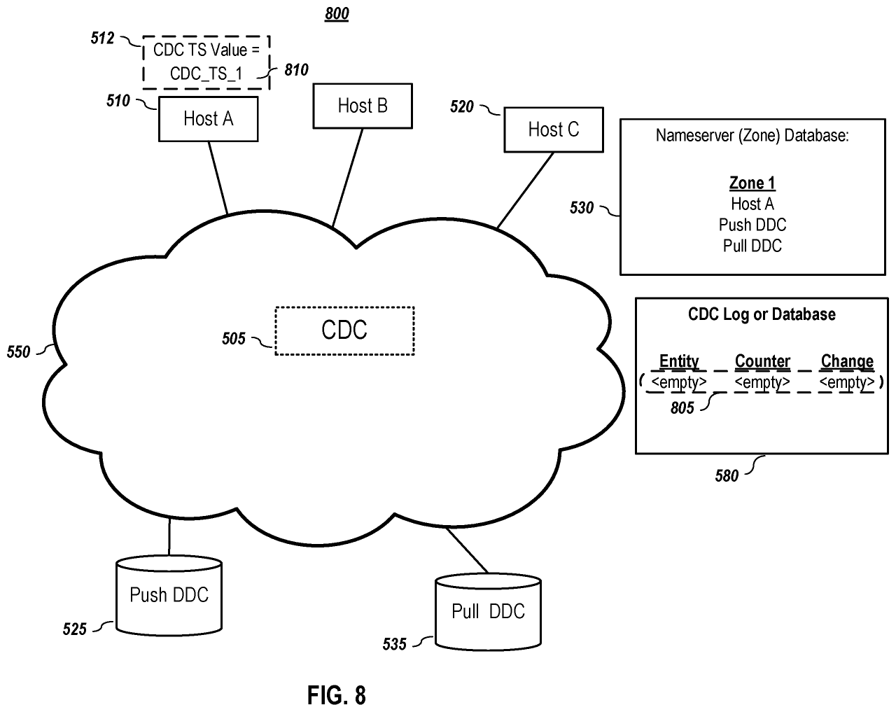

FIG. 8 depicts an update to the log/database following successful sending of the response, according to embodiments of the present disclosure. Item 805 in FIG. 8 shows that the entry related to the pull DDC has been removed since that information has been communicated to all relevant entities.

Returning to FIG. 6B, host A 110 receives (660) the response from the CDC that includes information about any and all entities in a zone with host A that has a change with a CDC timestamp value greater than its value. Host A may then update (665) information about the entity or entities based upon information in the response. In one or more embodiments, host A 110 may also update its last seen CDC timestamp value to the CDC timestamp value indicated in the response from the CDC. FIG. 8 shows that the CDC timestamp value 810 for host A has been updated to CDC TS 1.

Note that, in one or more embodiments, the CDC timestamp value may be higher under different circumstances. For example, assume that shortly after the pull DDC 525 experienced its event that registered as a change, the push DDC 535 may have undergone one or more events that were detected and logged by the CDC. The CDC timestamp value for the push DDC 535 would be later than that for the pull DDC 525. Also assume that before any notifications related to the push DDC changes were sent to host A, the CDC received the request (step 640) from host A that was in response to the notification (step 630) sent regarding the pull DDC. In reply, the CDC may send information related to any entity (at least any storage subsystems) in a zone with host A that had a CDC timestamp value greater than the one supplied by host A 510 in its request to the CDC. In one or more embodiments, the information exchange may be limited per zone. Thus, information about both the pull DDC and the push DDC would be sent in response. Note also that the CDC timestamp value for host A would be set to the latest CDC timestamp, since it has now seen all changes up to that time.

In yet other embodiments, an NVMe may be configured to request an update from the CDC based upon one or more different triggers. For example, an NVMe entity may make a get log page request of the CDC at periodic intervals, following its own change event, and/or other triggers.

### 3. Embodiments of Data Exchange

To help facilitate or implement the exchange of information related to embodiments of versioning, one or more of the following changes may be made to communications. For example, the following changes may be made to packet frames of the NVM Express™ Base Specification Rev. 1.1a (2021.07.12-Ratified), which is incorporated herein in its entirety. The Base Specification Rev. 1.1a was produced by the NVM Express™ organization-a non-profit consortium of technology industry leaders. It shall be noted that other types and formats of command/communication may be employed.

a. For Counter-Based Embodiments

In one or more embodiments, a command Dword 15 in a Get Log Page request may be used to accommodate a counter as follows:

### Get Log Page-Command DWORD 15

| Bits | Description |
|---|---|
| 31:00 | Generation Counter (GENCTR): Indicates the version of the |
| | discovery information, based on this number get log page |
| | is returned for specific generation/version counter number. |

NVMe utilizes a variety of data structures and commands to communicate with and manage SSDs (Solid State Drives) over the PCIe bus. An NVMe DWORD stands for “Double Word,” which is a data type used in computing. In these structures and commands, data is often transferred in units of DWORDs, where each DWORD typically comprises 32 bits or 4 bytes of data. References to NVMe DWORDs generally means that data transfers or command parameters are being specified in terms of 32-bit units.

b. For Timestamp-Based Embodiments

In one or more embodiments, a timestamp-based get log page command denotes some time. For example, it may be the number of seconds elapsed since a start time (e.g., midnight on a certain date). Using this field in the get log page request, an end device entity may query the list of get log pages that has been modified since the mentioned time value. The timestamp may be accommodated in the command DWORD 15 in a get log page request as follows.

### Get Log Page-Command DWORD 15

| Bits | Description |
|---|---|
| 31:00 | Timestamp: Number of seconds (or some other time measurement |
| | unit) that has elapsed since a certain time (e.g., since |
| | midnight of a 01 Jan. 2024) |

c. Indicator Embodiments

In one or more embodiments, one or more indicators may be used to indicate if all log page entries or a subset of them are returned. For example, a couple of bits may be used to indicate if all log page entries or a subset of log page entries are being returned.

### Get Log Page-Command DWORD 14

| Bits | Description |
|---|---|
| 31:24 | Command Set Identifier (CS1) |
| 23 | Offset Type (OT) |

### Get Log Page-Command DWORD 14

| Bits | Description |
|---|---|
| 22:09 | Reserved |
| 08 | Differential Get Log Page specifier: |
| | If cleared to ‘0’, all log page entries are returned; and |
| | If set to ‘1’, then only a subset of log page entries is returned, according |
| | to the generation counter or timestamp specified in DWORD15. |
| 07 | Dword 15 discriminator: indicated the content of Dword 15 as follows |
| | If cleared to ‘0’, then DWORD 15 contains a generation counter; |
| | If set to '1', then DWORD 15 contains a timestamp |

Thus, embodiments of the present patent document provide minimal subset of log pages for hosts and/or storage subsystems with a large number of devices registered with CDC by utilizing a form of versioning (e.g., generation counter or timestamp).

Embodiments may also be easily applied to DDCs by including the above-specified fields in a Log Page Request Operation Specific Parameters for a DDC Request Log Page as follows:

### New-Log Page Request Operation Specific Parameters for DDC Request Log

| Bytes | Description |
|---|---|
| 00 | Log Page Request Log Page Identifier (LPRLID) |
| 01 | Log Page Request Log Specific Parameter (LPRLSP) |

### New-Log Page Request Operation Specific Parameters for DDC Request Log Page

| Bytes | Description |
|---|---|
| 02 | Differential Get Log Page specifier: |
| | If cleared to 00 h, then all log page entries are requested; |
| | If set to 01 h, then only a subset of log page entries is requested, |
| | according to the generation counter specified in the |
| | GenCount/TimeStamp field; |
| | If set to 02 h, then only a subset of log page entries is requested, |
| | according to the timestamp specified in the GenCount/TimeStamp |
| | field. |
| 03 | Reserved |
| 07:04 | GenCount/TimeStamp: as defined above. |

It shall be noted that messaging and indicators may be configured differently and may comprise different information.

### C. System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drives, solid state drive, or both), one or more network ports for communicating with external devices as well as various input and output (I/O) devices. The computing system may also include one or more buses operable to transmit communications between the various hardware components.

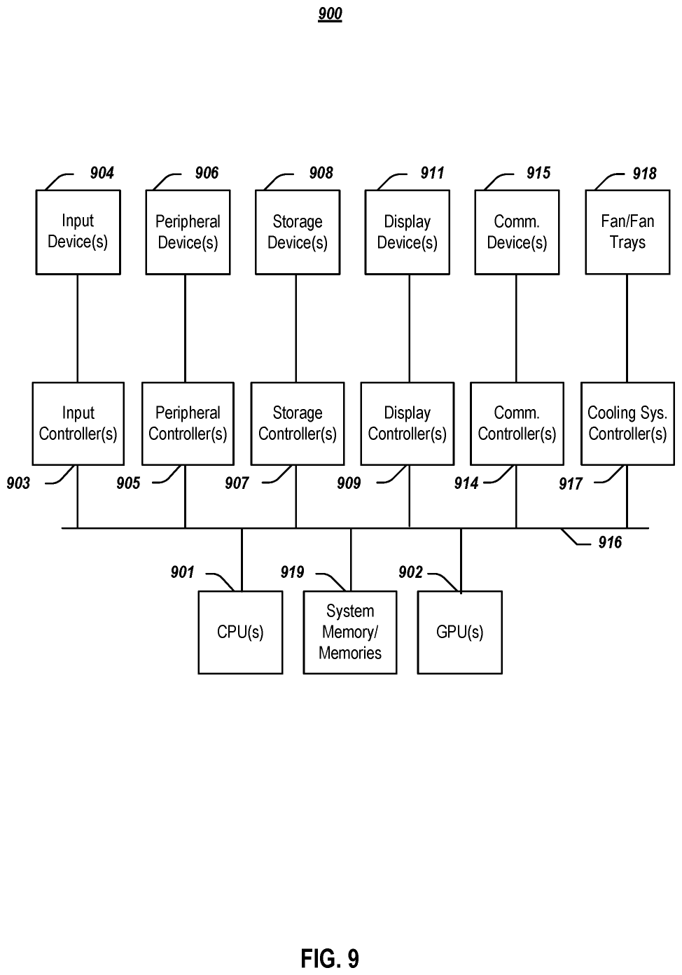

FIG. 9 depicts a simplified block diagram of an information handling system (or computing system), according to embodiments of the present disclosure. It will be understood that the functionalities shown for system 900 may operate to support various embodiments of a computing system—although it shall be understood that a computing system may be differently configured and include different components, including having fewer or more components as depicted in FIG. 9.

As illustrated in FIG. 9, the computing system 900 includes one or more CPUs 901 that provides computing resources and controls the computer. CPU 901 may be implemented with a microprocessor or the like and may also include one or more graphics processing units (GPU) 902 and/or a floating-point coprocessor for mathematical computations. In one or more embodiments, one or more GPUs 902 may be incorporated within the display controller 909, such as part of a graphics card or cards. The system 900 may also include a system memory 919, which may comprise RAM, ROM, or both.

A number of controllers and peripheral devices may also be provided, as shown in FIG. 9. An input controller 903 represents an interface to various input device(s) 904, such as a keyboard, mouse, touchscreen, stylus, microphone, camera, trackpad, display, etc. The computing system 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present disclosure. Storage device(s) 908 may also be used to store processed data or data to be processed in accordance with the disclosure. The system 900 may also include a display controller 909 for providing an interface to a display device 911, which may be a cathode ray tube (CRT) display, a thin film transistor (TFT) display, organic light-emitting diode, electroluminescent panel, plasma panel, or any other type of display. The computing system 900 may also include one or more peripheral controllers or interfaces 905 for one or more peripherals 906. Examples of peripherals may include one or more printers, scanners, input devices, output devices, sensors, and the like. A communications controller 914 may interface with one or more communication devices 915, which enables the system 900 to connect to remote devices through any of a variety of networks including the Internet, a cloud resource (e.g., an Ethernet cloud, a Fibre Channel over Ethernet (FCOE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 900 comprises one or more fans or fan trays 918 and a cooling subsystem controller or controllers 917 that monitors thermal temperature(s) of the system 900 (or components thereof) and operates the fans/fan trays 918 to help regulate the temperature.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

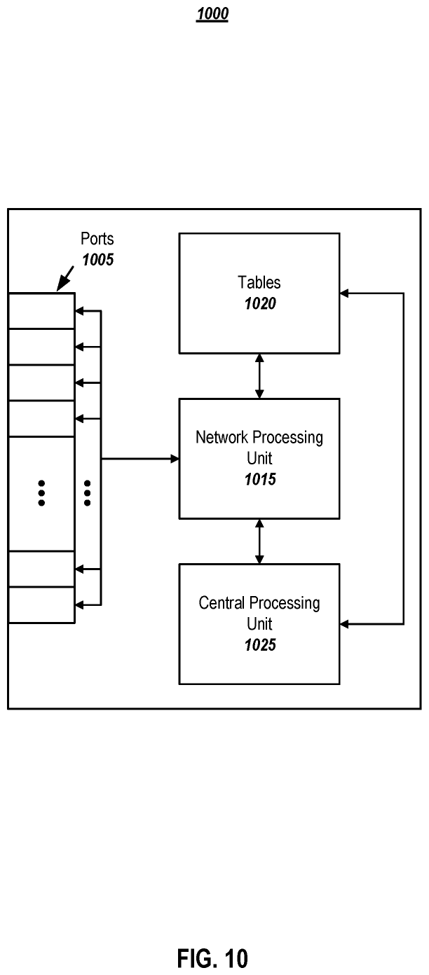

FIG. 10 depicts an alternative block diagram of an information handling system, according to embodiments of the present disclosure. It will be understood that the functionalities shown for system 1000 may operate to support various embodiments of the present disclosure—although it shall be understood that such system may be differently configured and include different components, additional components, or fewer components.

The information handling system 1000 may include a plurality of I/O ports 1005, a network processing unit (NPU) 1015, one or more tables 1020, and a CPU 1025. The system includes a power supply (not shown) and may also include other components, which are not shown for sake of simplicity.

In one or more embodiments, the I/O ports 1005 may be connected via one or more cables to one or more other network devices or clients. The network processing unit 1015 may use information included in the network data received at the node 1000, as well as information stored in the tables 1020, to identify a next device for the network data, among other possible activities. In one or more embodiments, a switching fabric may then schedule the network data for propagation through the node to an egress port for transmission to the next destination.

Aspects of the present disclosure may be encoded upon one or more non-transitory computer-readable media comprising one or more sequences of instructions, which, when executed by one or more processors or processing units, causes steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented/processor-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as compact discs (CDs) and holographic devices; magneto-optical media; and hardware devices that are specially configured to store or to store and execute program code, such as ASICs, PLDs, flash memory devices, other non-volatile memory devices (such as 3D XPoint-based devices), ROM, and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A processor-implemented method comprising:
responsive to detecting a change to a non-volatile memory express (NVMe) entity:
creating or updating an entry in a datastore that correlates the NVMe entity that experienced a change (“the changed NVMe entity”) to an event indicator; and
sending a notification to one or more other NVMe entities that are associated with the changed NVMe entity;
receiving a request for information from a requesting NVMe entity that received the notification, in which the request comprises a last seen value of the requesting NVMe entity;
identifying NVMe entities that are associated with the requesting NVMe entity that have a value greater than the last seen value of the requesting NVMe entity; and
sending a response to the requesting NVMe entity that comprises information about the NVMe entity or NVMe entities with values greater than the last seen value of the requesting NVMe entity.

2. The processor-implemented method of claim 1 wherein the entry also comprises an indication of what changed for the changed NVMe entity.

3. The processor-implemented method of claim 1 wherein the one or more other NVMe entities that are associated with the changed NVMe entity are NVMe entities that are in a zone with the changed NVMe entity.

4. The processor-implemented method of claim 1 wherein the value is a counter value and the method further comprises:
updating the requesting NVMe entity's last seen counter value in an entry in the datastore to a highest counter value of an NVMe entity that is included in the response sent to the requesting NVMe entity.

5. The processor-implemented method of claim 1 wherein the response is a response to a get log page request.

6. The processor-implemented method of claim 1 wherein the response includes an indication of what changed.

7. The processor-implemented method of claim 1 further comprising:
determining from a log page request whether the requesting NVMe entity is requesting a subset of log page entries based upon versioning or requesting all log page entries.

8. The processor-implemented method of claim 1 wherein each NVMe entity included in the response has experienced at least one change since the last seen value of the requesting NVMe entity was set.

9. An information handling system comprising:
one or more processors; and
a non-transitory computer-readable medium or media comprising one or more sets of instructions which, when executed by at least one of the one or more processors, causes steps to be performed comprising:
responsive to detecting a change to a non-volatile memory express (NVMe) entity, creating or updating an entry in a datastore that correlates the NVMe entity that experienced a change (“the changed NVMe entity”) to an event indicator;
receiving a request for information from a requesting NVMe entity, in which the request comprises a last seen value of the requesting NVMe entity;
identifying NVMe entities that are associated with the requesting NVMe entity that have a value greater than the last seen value of the requesting NVMe entity; and
sending a response to the requesting NVMe entity that comprises information about the NVMe entity or NVMe entities with values greater than the last seen value of the requesting NVMe entity.

10. The information handling system of claim 9 wherein the entry also comprises an indication of what changed for the changed NVMe entity.

11. The information handling system of claim 9 wherein the value is a counter value and the non-transitory computer-readable medium or media further comprises one or more sequences of instructions which, when executed by at least one of the one or more processors, causes steps to be performed comprising:
updating the requesting NVMe entity's last seen counter value in an entry in the datastore to a highest counter value of an NVMe entity that is included in the response sent to the requesting NVMe entity.

12. The information handling system of claim 9 wherein the non-transitory computer-readable medium or media further comprises one or more sequences of instructions which, when executed by at least one of the one or more processors, causes steps to be performed comprising:
sending a notification to one or more other NVMe entities that are associated with the changed NVMe entity.

13. The information handling system of claim 12 wherein the one or more other NVMe entities that are associated with the changed NVMe entity are NVMe entities that are in a zone with the changed NVMe entity.

14. The information handling system of claim 9 wherein the response includes an indication of what changed.

15. The information handling system of claim 9 wherein the non-transitory computer-readable medium or media further comprises one or more sequences of instructions which, when executed by at least one of the one or more processors, causes steps to be performed comprising:
determining from a log page request whether the requesting NVMe entity is requesting a subset of log page entries based upon versioning or requesting all log page entries.

16. A processor-implemented method comprising:
responsive to detecting, by a centralized discovery controller (CDC), a change to a non-volatile memory express (NVMe) entity, creating or updating an entry in a datastore that correlates the NVMe entity that experienced a change (“the changed NVMe entity”) to an event indicator;
receiving, at the CDC, a request for information from a requesting NVMe entity, in which the request comprises a last seen value of the requesting NVMe entity;
identifying NVMe entities that are associated with the requesting NVMe entity that have a value greater than the last seen value of the requesting NVMe entity; and
sending, from the CDC, a response to the requesting NVMe entity that comprises information about the NVMe entity or NVMe entities with values greater than the last seen value of the requesting NVMe entity.

17. The processor-implemented method of claim 16 wherein the request from the requesting NVMe entity is triggered by one condition from a set of one or more conditions.

18. The processor-implemented method of claim 17 wherein one condition is expiration of a time interval.

19. The processor-implemented method of claim 17 wherein one condition is receipt, by the requesting NVMe entity, of a notification from the CDC that a change has occurred.

20. The processor-implemented method of claim 16 wherein:
if the value is a counter value, the method further comprises:
updating the requesting NVMe entity's last seen counter value in an entry in the datastore to a highest counter value of an NVMe entity that is included in the response sent to the requesting NVMe entity; and
if the value is a timestamp value, the method further comprises:
purging all entries that were reported to NVMe entities that are associated with the changed NVMe via zoning.
